(19) United States
(12) Patent Application Publication
(10) Pub. No.: US 2014/0337017 A1
(43) Pub. Date: Nov. 13, 2014

(54) Method for Converting Speech Using Sparsity Constraints

(71) Applicant: MITSUBISHI ELECTRIC RESEARCH LABORATORIES, INC., Cambridge, MA (US)

(72) Inventors: Shinji Watanabe, Arlington, MA (US); John R. Hershey, Winchester, MA (US)

(73) Assignee: Mitsubishi Electric Research Laboratories, Inc., Cambridge, MA (US)

(21) Appl. No.: 13/890,353

(22) Filed: May 9, 2013

(51) Int. Cl. G10L 19/02

(52) U.S. Cl. CPC G10L 19/0212
USPC 704/204

(57) ABSTRACT

A method converts source speech to target speech by first mapping the source speech to sparse weights using compressive sensing technique, and the transforming, using transformation parameters, the sparse weights to the target speech.

### FIELD OF THE INVENTION

This invention relates generally processing speech, and more particularly to converting source speech to target speech.

### BACKGROUND OF THE INVENTION

Speech enhancement for automatic speech recognition (ASR) is one of the most important topics for many speech applications. Typically speech enhancement removes noise. However, speech enhancement does not always improve the performance of the ASR. In fact, speech enhancement can degrade the ASR performance even when the noise is correctly subtracted.

The main reason for the degradation comes from a difference of speech signal representations between power spectrum and Mel-frequency cepstral coefficient (MFCC) domains. For example, spectral subtraction can drastically denoise speech signals. However, because spectral subtraction makes speech signals unnatural, e.g., discontinuities due to a flooring process, outliers are enhanced during the MFCC feature extraction step, which degrades the ASR performance.

One method deals with the denoising problem in the MFCC domain that does not retain the additivity property of signals and noises, unlike the power spectrum domain. That method does not drastically reduce noise components because the method directly enhances the MFCC features. Therefore, that method yields better denoised speech in terms of the ASR performance.

Speech Conversion Method

FIG. 1 shows a conventional method for converting noisy source speech 104 to target speech 103 that uses training 110 and conversion 120. The method derives statistics according to a Gaussian mixture model (GMM).

Training

During training step, transformation matrices are estimated 114 from training source speech 102 and training target speech 101, which are so called parallel (stereo) data that have the same linguistic contents. A target feature sequence is

X={xₜεR^{D}|t=1, . . . ,T},

and a source feature sequence is

Y={yₜεR^{D}|t=1, . . . ,T},

where T is the number of speech frames, D) is the number of dimensionality, and X and Y D×T matrices.

Herein, speech and features of the speech are used interchangeable in that allmost all speech processing methods operate on features extracted from speech signals, instead of on the raw speech signal itself. Therefore, it is understood that the term “speech” and a speech signal can be a speech feature vector.

Feature Mapping

In the feature mapping module 112, the source feature yₜ is mapped to a posterior probability γ_{k,t} of a Gaussian mixture component k at a frame t as

$${γ}_{k , t} = \frac{N ( {y}_{t} \vert k , Θ )}{{\sum }_{k = 1}^{K} N ( {y}_{t} \vert k , Θ )} , \qquad ( 1 )$$

where K is the number of components and Θ is a set of parameters of the GMM. N( ) is a Gaussian distribution.

Transformation Parameter Estimation

For the posterior probability γ_{k,t}, a linear transformation is

$${x}_{t} = {y}_{t} + {\sum }_{k = 1}^{K} {b}_{k} {γ}_{k , t} \qquad ( 2 )$$

where bₖ is a bias vector that represents a transformation from yₜ to xₜ. The linear transformation matrix of the speech feature vectors, e.g., Σₖ₌₁^{K}γ_{k,t}(Aₖyₜ+bₖ), where Aₖ is a matrix of weights, can also be considered. However, it is practical to consider only bias vectors because the linear transformation does not necessarily improve the ASR performance and requires a complicated estimation process.

The transformation parameter estimation module estimate bₖ statistically. By considering the above process for all frames, Eq. (2) is represented in the following matrix form:

$$X = Y + B Γ = [ {I}_{D} B ] [ \begin{matrix}Y \\ Γ\end{matrix} ] , \qquad ( 3 )$$

where I_{D} is the D×D identity matrix, Γ is a K×T matrix composed of the posterior probabilities {{γ_{k,t}}ₖ₌₁^{K}}ₜ₌₁^{T}, B is a D×K matrix composed of K bias vectors, i.e., B=[bₖ₌₁, . . . , b_{k=K}].

Eq. (3) indicates the interpretation that the source signal Y is represented in an augmented feature space [Y^{T}, Γ^{T}]^{T} by expanding the source feature space with the Gaussian posterior-based feature space. That is, the source signal is mapped into points in the high-dimensional space, and the transformation matrix [I, B] can be obtained as a projection from the augmented feature space to the target feature space.

The bias matrix is obtained by minimum mean square error (MMSE) estimation

$${argmin}_{B} {‖ X - Y - B Γ ‖}_{2}^{2} , \qquad ( 4 )$$

Thus, the bias matrix is estimated as:

\hat{B}=(X−Y)Γ^{T}(ΓΓ^{T})⁻¹. (5)

The transformation parameter estimation module estimate \hat{B} 115, which is used by the conversion.

Conversion

The conversion operates on actual source speech Y′ 104 and target speech X′ 103.

Source speech feature y′ₜ uses the estimated transformation parameter \hat{B} 115.

Feature Mapping

The mapping module 112, as used during training, maps the source feature y′ₜ to the posterior probability γ′_{k,t} as

$${γ}_{k , t}^{′} = \frac{N ( {y}_{t}^{′} \vert k , Θ )}{{\sum }_{k = 1}^{K} N ( {y}_{t}^{′} \vert k , Θ )} . \qquad ( 6 )$$

Conversion

The source speech feature y′ₜ is converted using γ′_{k,t} and the estimated transformation parameter \hat{B} as

$${x}_{t}^{′} = {y}_{t}^{′} + {\sum }_{k = 1}^{K} {γ}_{k , t}^{′} {\hat{b}}_{k} . \qquad ( 7 )$$

Thus, the conventional method realizes high-quality speech conversion. The key idea of that method is the mapping to the high-dimensional space based on the GMM to obtain non-linear transformation of the source to target features. However, the GMM based conventional mapping module has the following two problems.

High Dimensionality

The full-covariance Gaussian distribution cannot be correctly estimated when the number of dimensions is very large. Therefore, the method can only use small dimensional features. In general, speech conversion has to consider long context information, e.g., by concatenating several frames of features

X_{t,c}⁽ⁿ⁾=[(X_{t-c}⁽ⁿ⁾)^{T}, . . . ,(Xₜ⁽ⁿ⁾)^{T}, . . . ,(X_{t+c}⁽ⁿ⁾)^{T}]^{T}).

However, the GMM based approach cannot consider this long context directly due to the dimensionality problem.

### SUMMARY OF THE INVENTION

The embodiments of the invention provide a method for converting source speech to target speech. The source speech can include noise, which is reduced during the conversion. However, the conversion can deal with other types of source to target conversions, such speaker normalization, which converts a specific speaker's speech to a canonical speaker's speech data, and voice conversion, which converts speech of a source speaker to that of a target speaker. In addition to the above inter-speaker conversion, the voice conversion can deal with the intra-speaker variation, e.g., by synthesizing various emotional speech of the same speaker and so on.

The method uses compressive sensing (CS) weights during the conversion, and dictionary learning in a feature mapping module. Instead of using posterior values obtained by a GMM as in conventional methods, the embodiments use sparsity constraints and obtains sparse weight as a representation of the source speech. The method maintains accuracy even when the dimensionality of the signal is very large.

### BRIEF DESCRIPTION OF THE DRAWINGS

FIG. 1 is a flow diagram of a convention speech conversion method;

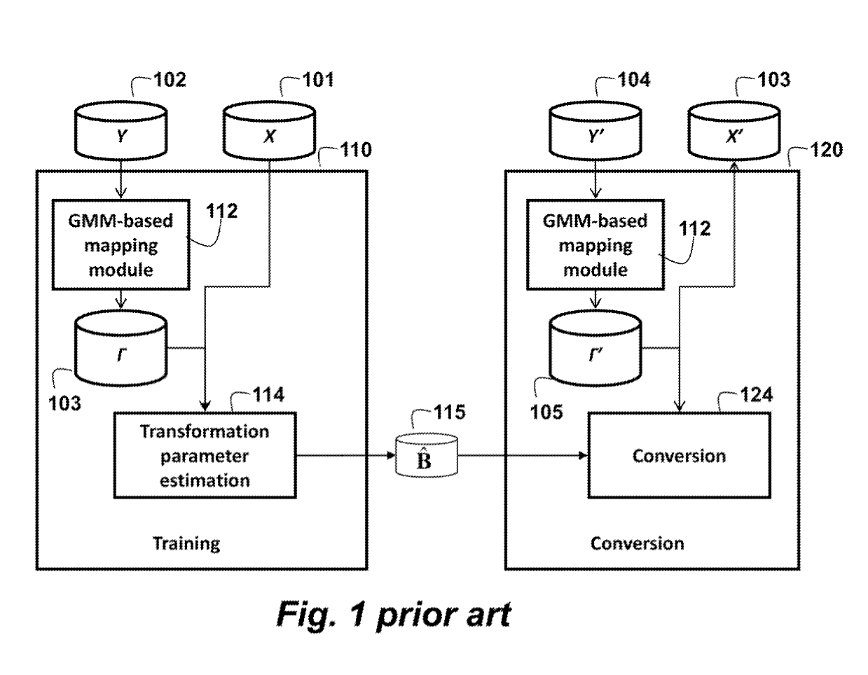

FIG. 2 is a flow diagram of a speech conversion method according to embodiments of the invention;

FIG. 3 is a pseudo code of a dictionary learning process according to embodiments of the invention; and

FIG. 4 is pseudo code of a transformation estimation process according to embodiments of the invention.

### DETAILED DESCRIPTION OF THE PREFERRED EMBODIMENTS

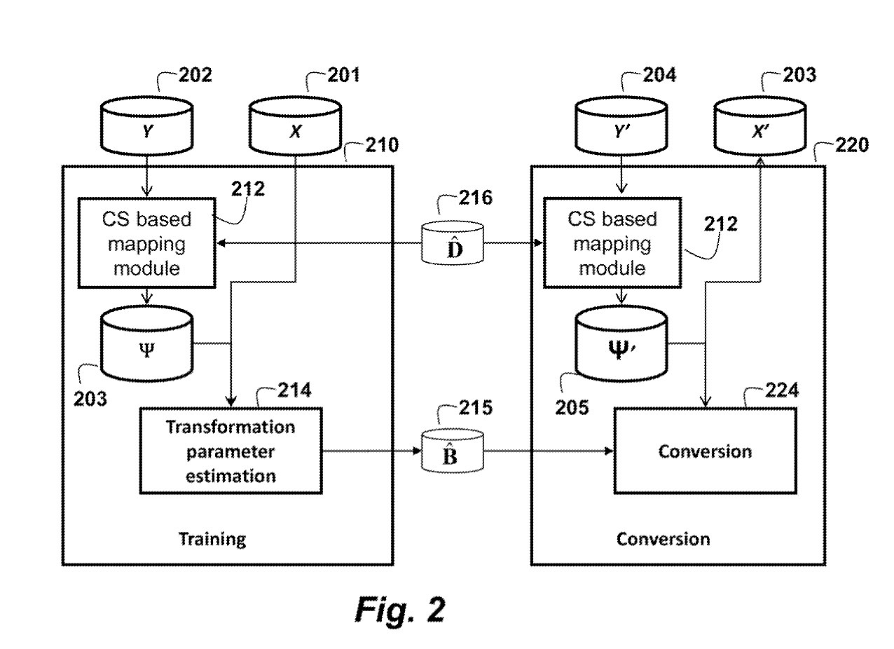

FIG. 2 shows a method for converting source speech 204 to target speech 203 of embodiments of our invention. In one application, the source speech includes noise that is reduced in the target speech. In voice conversion, source speech is source speakers' speech and the target speech is target speaker's speech. In speaker normalization, source speech is specific speaker's speech and target speech is canonical speaker's speech.

The method includes training 210 and conversion 220. Instead of using the GMM mapping is in the prior art, we use a compressive sensing (CS)-based mapping 212. Compressed sensing uses a sparsity constraint that only allows solutions that have a small number of nonzero coefficients in data or a signal that contains a large number of zero coefficients. Hence, sparsity is not an indefinite term, but a term of art in CS. Thus, when the terms “sparse” or “sparsity” are used herein and in the claims, it is understood that we are specifically referring to a CS-based method.

We use the CS-based mapping to determine sparse weights

Ψ={φₜεR^{D}|t=1, . . . ,T},

even when the dimensionality of the source speech is large.

To estimate the sparse weight, we use a D×K matrix \hat{D} that forms a dictionary 216. We use the following decomposition

$${argmin}_{D , {w}_{t}} {‖ {y}_{t} - {Dw}_{t} ‖}_{2}^{2} + Λ ( {w}_{t} ) ∀ t , \qquad ( 8 )$$

where wₜ is a vector of the weights at a frame t, Λ(wₜ) is a regularization term for the weights. The [symbol] ₁ norm is usually used to determine a sparse solution.

In the transformation estimation step, we use

$${argmin}_{B} {‖ X - Y - B Ψ ‖}_{2}^{2} . \qquad ( 9 )$$

As in Eq. (4) of the prior art, except that the feature vector φₜ, is instead obtained from wₜ, by the CS-based mapping module 212 as described below.

Compressive-Sensing-Based Mapping Module

Two approaches can be used to obtain the sparse weights. The first approach is orthogonal matching pursuit (OMP). OMP is a greedy search procedure used for the recovery of compressive sensed sparse signals.

$${argmin}_{{w}_{t}} ‖ {w}_{t} ‖ 0 s . t . {‖ {y}_{t} - {Dw}_{t} ‖}_{2}^{2} \leq ɛ . \qquad ( 10 )$$

This approach determines a smallest number of non-zero elements among wₜ that satisfies an upper bound (ε) of a residual of the source speech.

The second approach uses a least absolute shrinkage and selection operator (Lasso), which uses the [symbol] ₁ regularization term to obtain the sparse weights

$${argmin}_{{w}_{t}} {‖ {y}_{t} - {Dw}_{t} ‖}_{2}^{2} + λ {‖ {w}_{t} ‖}_{1} . \qquad ( 11 )$$

λ is a regularization parameter.

After we obtain the sparse weights, we can determine the posterior probabilities of each dictionary element k as follows:

$$p ( k \vert {y}_{t} ) = \frac{p ( {y}_{t} \vert k )}{{\sum }_{k = 1}^{K} p ( {y}_{t} \vert k )} ∝ exp ( - \frac{{‖ {y}_{t} - {w}_{k , t} {d}_{k} ‖}_{2}^{2}}{2 {σ}^{2}} ) , \qquad ( 12 )$$

where σ² is a variance parameter, which can be estimated from the speech or set manually. Because of the sparseness of w_{k,t}, the computational cost of this posterior estimation is very low.

For the feature ψ_{k,t} for the latter transformation step, we have the following two options:

Weight: ψ_{k,t} [symbol] w_{k,t}, and

Posterior probability: ψ_{k,t} [symbol] p(k|yₜ).

Dictionary Learning

The dictionary can be learned, e.g., using a method of optimal direction (MOD). MOD is based on Lloyd's algorithm, also known as Voronoi iteration or relaxation, to group data points into categories. The MOD estimates D as follows

\tilde{D}=ƒ_{nc}(YW^{T}(WW^{T})⁻¹), (13)

where ƒ_{nc}( ) is a function used to normalize the column vectors k to be unit vectors, e.g.,

\tilde{d}ₖ→\tilde{d}ₖ/|\tilde{d}ₖ|.

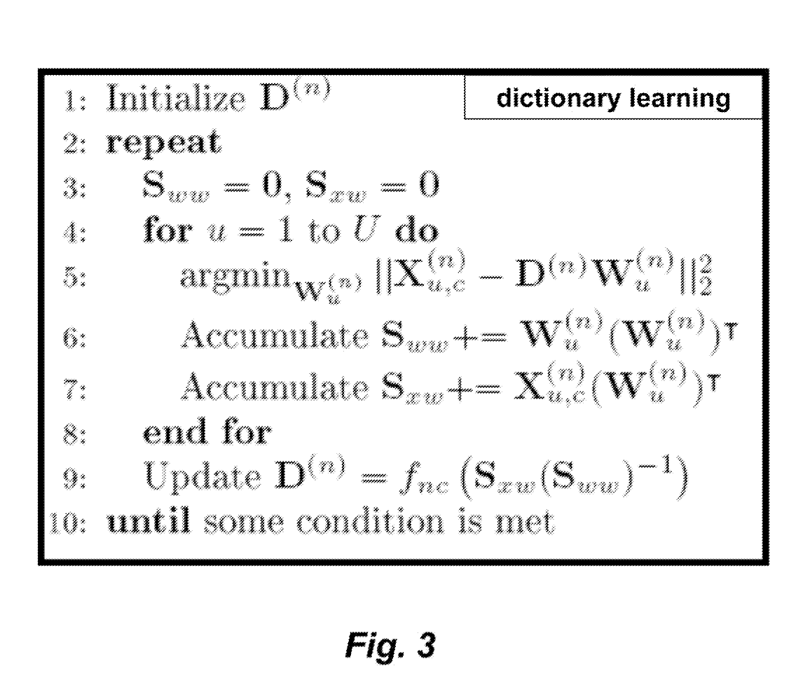

There are other approaches for estimating the dictionary matrix, e.g., k-singular value decomposition (SVD), and online dictionary learning. The dictionary matrix and sparse vectors are iteratively updated, as shown in FIG. 3.

Transformation Estimation

After we obtain the weights and the dictionary 216, we can consider the similar transformation to Eq. (2) by replacing γ_{k,t} with ψ_{k,t}, as

$${x}_{t} = {y}_{t} + {\sum }_{k = 1}^{K} {ψ}_{k , t} {b}_{k} , \qquad ( 14 )$$

or we can represent this equation with a weight matrix Ψ as

X=Y+BΨ. (15)

By using the same MMSE criterion with Eq. (4), we can obtain the following transformation matrix:

\tilde{B}=(X−Y)Ψ^{T}(ΨΨ^{T})⁻¹, (16)

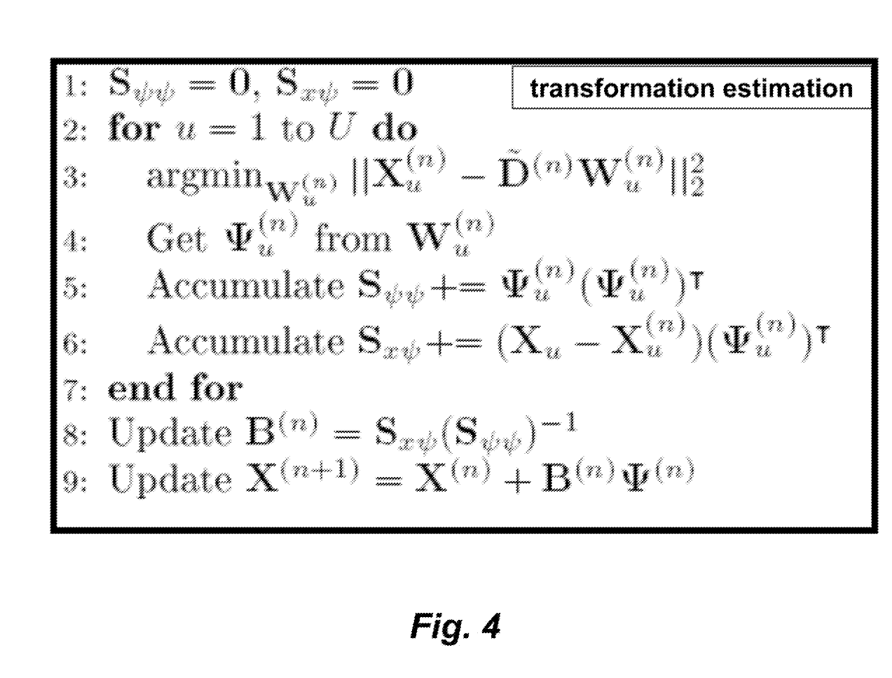

Thus, the we first map the source speech Y to the sparse weights Ψ using the dictionary, and then the sparse weights are transformed to the bias vectors \hat{B}Ψ between target and source feature vectors, see FIG. 4.

Multistep Feature Transformation

Because our method converts source features to target features in the same speech feature domain, the process can be iterative. We consider the following extension of feature transformation from Eq. (15)

X⁽ⁿ⁺¹⁾=X⁽ⁿ⁾+B⁽ⁿ⁾Ψ⁽ⁿ⁾, (17)

where n is the number of transformation step and X⁽¹⁾ [symbol] Y. The sparse vectors and the transformation matrix are estimated step-by-step as

$${argmin}_{{D}^{( n )} , {w}_{t}^{( n )}} {‖ {x}_{t}^{( n )} - {D}^{( n )} {w}_{t}^{( n )} ‖}_{2}^{2} + Λ ( {w}_{t}^{( n )} ) ∀ t . \\ {B}^{( n )} = ( X - {X}^{( n )} ) {( {Ψ}^{( n )} )}^{T} {( {{Ψ}^{( n )} ( {Ψ}^{( n )} )}^{T} )}^{- 1} . \qquad ( 18 )$$

The iterative process monotonically decreases the [symbol] 2 norm during the training.

Long Context Features

Our method can consider long context information. There are two ways of considering long context features. One is to consider the context information in the posterior domain at the transformation step, i.e.,

γ_{t,c}=[γ_{t-c}^{T}, . . . ,γₜ^{T}, . . . ,γ_{t+c}^{T}]^{T},

where c is the number of contiguous frames to be considered in this feature expansion. The other is to consider the long context features in the dictionary learning step, i.e.,

X_{t,c}⁽ⁿ⁾=[(X_{t-c}⁽ⁿ⁾)^{T}, . . . ,(Xₜ⁽ⁿ⁾)^{T}, . . . ,(X_{t+c}⁽ⁿ⁾)^{T}]^{T}.

In general, because the GMM cannot correctly deal with high-dimensional features because of the dimensionality problem, the conventional approach uses the posterior domain feature expansion. One of the advantages of dictionary learning is that the approach does not significantly suffer from the dimensionality problem unlike the Gaussian mixture case. In addition, by considering multistep transformation, as described above, the transformation step can consider a longer context. Thus, the embodiments use the long context features in the dictionary learning step.

Implementation

An important factor in applying our method to speech processing is that we consider the computational efficiency of dealing with large-scale speech database, e.g., over five million speech feature frames, which cannot easily be stored. Therefore, we use utterance-by-utterance processing of dictionary learning and transformation estimation, which only stores utterance unit features, weights, and posteriors.

We consider an utterance index u with Tᵤ frames. The set of sparse weights for a particular corpus is represented as Wᵤ, Other frame-dependent values are represented similarly. We mainly have to determine the statistics

WW^{T},ΨΨ^{T},YW^{T},

(X−Y)Ψ^{T}.

We use the following relationship of the sub-matrix property:

$${WW}^{T} = {\sum }_{u = 1}^{U} {W}_{u} {W}_{u}^{T} . \qquad ( 19 )$$

This Eq. (19) indicates that we can determine X, Y, W and Ψ, without storing these matrices in memory, by accumulating these statistics for each utterance, similar to an expectation-maximization (EM) process. However, some dictionary learning techniques, e.g., k-SVD need to explicitly process full frame size matrices, and cannot be represented by Eq. (19). In this case, an online learning based extension is required. We can also parallelize the method for each utterance, or set of utterances.

FIG. 3 shows pseudocode for the dictionary learning, and FIG. 4 for the transformation estimation. The variables used in the pseudocode are described in detail above. All the steps described herein can be performed in a processor connected to memory and input/output interfaces as known in the art.

Although the invention has been described with reference to certain preferred embodiments, it is to be understood that various other adaptations and modifications can be made within the spirit and scope of the invention. Therefore, it is the object of the append claims to cover all such variations and modifications as come within the true spirit and scope of the invention.

We claim:

1. A method for converting source speech to target speech, comprising the steps of:
mapping the source speech to sparse weights; and
transforming, using transformation parameters, the sparse weights to the target speech, wherein the steps are performed in a processor.

2. The method of claim 1, wherein the source speech includes noise that is reduced in the target speech.

3. The method of claim 1, wherein the mapping is compressive sensing (CS) based.

4. The method of claim 1, wherein the sparse weights are obtained from a dictionary.

5. The method of claim 1, wherein the sparse weights are obtained using orthogonal matching pursuit.

6. The method of claim 1, wherein the sparse weights are a smallest number of non-zero weights that satisfies an upper bound of a residual of the source speech.

7. The method of claim 1, wherein the sparse weights are obtained using a least absolute shrinkage and selection operator.

8. The method of claim 4, further comprising:
determining a posterior probability for each element in the dictionary.

9. The method of claim 4, further comprising:
learning the dictionary using a method of optimal direction.

10. The method of claim 4, further comprising:
learning the dictionary using k-singular value decomposition.

11. The method of claim 1, wherein the transforming uses a minimum mean square error estimation.

12. The method of claim 1, wherein the transforming is according to bias vectors between target speech and the source speech.

13. The method of claim 1, mapping and transforming is parallelized.
